(19) United States
(12) Patent Application Publication
(10) Pub. No.: US 2023/0249406 A1
(43) Pub. Date: Aug. 10, 2023

(54) ADDITIVE MANUFACTURING SYSTEM AND QUALITY CONTROL SYSTEM AND METHOD FOR AN ADDITIVE MANUFACTURING SYSTEM

(71) Applicant: TRIEX, LLC, Barre, VT (US)

(72) Inventors: TYLER MCNANEY, BARRE, VT (US); SEAN MILLER, MONTPELIER, VT (US)

(73) Assignee: TRIEX, LLC, Barre, VT (US)

(21) Appl. No.: 18/107,057

(22) Filed: Feb. 8, 2023

Related U.S. Application Data
(60) Provisional application No. 63/308,228, filed on Feb. 9, 2022.

(51) Int. Cl. B29C 64/209; B29C 64/393; B29C 64/118; B33Y 30/00; B33Y 10/00; B33Y 50/02

(52) U.S. Cl. CPC B29C 64/209; B29C 64/393; B29C 64/118; B33Y 30/00; B33Y 10/00; B33Y 50/02

(57) ABSTRACT

A system for additive manufacturing includes an extrusion apparatus configured to receive a raw material and to output an extrudate, a print head configured to receive the extrudate and to output a bead to form an object, and a quality control system having at least one measurement device for measuring at least one of a bead width, a bead height and/or a bead temperature of the bead.

### CROSS-REFERENCE TO RELATED APPLICATIONS

This application claims the benefit of U.S. Provisional Application Ser. No. 63/308,228, filed on Feb. 9, 2022, which is hereby incorporated reference herein in its entirety.

### FIELD OF THE INVENTION

The present invention relates generally to additive manufacturing, and more particularly to quality control systems, devices and methods for use in additive manufacturing.

### BACKGROUND OF THE INVENTION

Additive manufacturing is a process of creating three-dimensional parts and structures from a CAD model or a digital 3D model by depositing overlapping layers of material under the guided control of a controller. Additive manufacturing can take many forms including, for example, fused deposition modeling (FDM) and fused particle fabrication (FPF). With FDM or FPF systems, a raw material is fed to an extrusion head or nozzle where it is heated and exits the nozzle as a flowable bead. Other systems, rather than heating the raw material at the extrusion head or nozzle, produce a flowable extrudate upstream from the nozzle, which is then conveyed to the nozzle via a melt tube. An example of such a system is disclosed in U.S. patent application Ser. No. 17/024,794, which is hereby incorporated by reference herein in its entirety. Other additive manufacturing technologies for creating a three-dimensional part through sintering, curing or melting of liquid, powdered or granular raw material, layer by layer, using ultraviolet light, high powered laser, or electron beam, are also know.

Regardless of the type of additive manufacturing, the height, width and temperature of the material being deposited or melted is critical in producing a part within desired tolerances, and to ensure each subsequent layer sufficiently bonds or fuses to the preceding layer. Variations in system components, ambient conditions, and the like, however, can sometimes have dramatic effects on the additive manufacturing process, sometimes pushing layer parameters outside of desired or required tolerances or optimal ranges. For example, additive manufacturing systems using material extrusion to produce a bead of flowable extrudate that is then deposited in layers to form a part can have fairly wide variations in extruder heating rates and screw shear rates. These variations directly affect the bead of extrudate that is produced and deposited, thus affecting the quality of the part or component produced.

Conventional quality assurance testing generally involves destruction of the part. While destructive testing is an accepted way of validating a part's quality, as it allows for close scrutiny of various internal portions of the part, such tests cannot, for obvious reasons, be applied to a production part.

In view of the above, there is a need for a system and method for monitoring bead and layer parameters in real-time, as the bead is deposited or layer formed, so that corrective action can be undertaken.

### SUMMARY OF THE INVENTION

In view of the foregoing, it is an object of the present invention to provide an additive manufacturing system.

It is an object of the present invention to provide a quality control system and method for additive manufacturing system.

It is an object of the present invention to provide a quality control system and method for additive manufacturing that allows for the sensing of layer parameters in real-time.

These and other objects are achieved by the present invention.

According to an embodiment of the present invention, a system for additive manufacturing includes an extrusion apparatus configured to receive a raw material and to output an extrudate, a print head configured to receive the extrudate and to output a bead to form an object, and a quality control system having at least one measurement device for measuring at least one of a bead width, a bead height and/or a bead temperature of the bead.

According to another embodiment of the present invention, a method of additive manufacturing, includes the steps of depositing a bead of material on a substrate according to a set of pre-programmed instructions, measuring at least one parameter of at least one of the bead and/or the substrate, comparing the measurement to a reference measurement stored in memory, and controlling at least one component of an additive manufacturing system in dependence upon the comparison.

According to yet another embodiment of the present invention, a system for additive manufacturing includes a print head configured to output a bead of flowable material to form an object, and a quality control system having at least one measurement device for obtaining a measurement of at least one of a bead width, a bead height and/or a bead temperature of the bead. The quality control system is configured to compare the measurement of the bead width, the bead height and/or the bead temperature of the bead with a reference measurement stored in memory and to adjust the system for additive manufacturing in real-time in dependence upon the comparison.

### BRIEF DESCRIPTION OF THE DRAWINGS

The present invention will be better understood from reading the following description of non-limiting embodiments, with reference to the attached drawings, wherein below:

FIG. 1 is schematic illustration of an additive manufacturing system according to an embodiment of the present invention.

FIG. 2 is an enlarged view of a print head of the additive manufacturing system of FIG. 1.

FIG. 3 is a schematic illustration of a quality control system of the additive manufacturing system of FIG. 1.

FIG. 4 is a schematic illustration of a measurement device arrangement of the quality control system of FIG. 3, according to one embodiment of the invention.

### DETAILED DESCRIPTION OF THE PREFERRED EMBODIMENTS

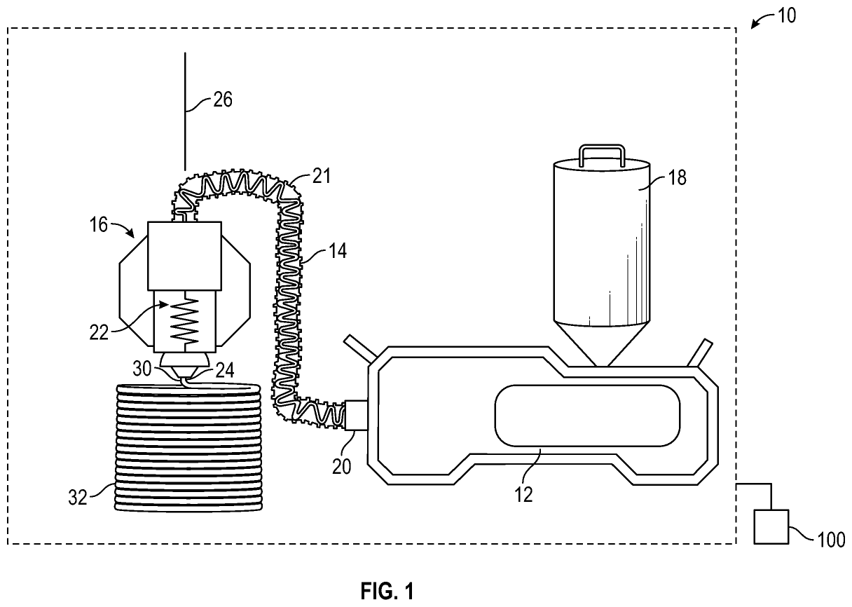

Referring to FIG. 1, an additive manufacturing system 10 according to an embodiment of the present invention is illustrated. As shown therein, the system 10 includes an extrusion apparatus 12, a conduit 14 fluidly connected to an outlet of the extrusion apparatus 12, and a print head 16 fluidly connected to an opposing end of the heated conduit 14 opposite the extrusion apparatus 12. The extrusion apparatus 12 may take the form of any extrusion apparatus 12 known in the art and which is capable of accepting a raw material, heating it, and extruding it through a die or outlet. For example, the extrusion apparatus 12 may be the MDPH2 or MDPE10 filament extruders sold by Massive Dimension. As shown in FIG. 1, the extrusion apparatus 12 includes a feed inlet or hopper 14 configured to accept a raw material for extrusion, and an outlet 20 configured to allow for egress of melted and flowable extrudate. In an embodiment, the raw material may be in the form of pellets, granules, shavings, flakes and/or powder. In an embodiment, the raw material may be, for example, thermoplastics such as polyethylene (PE), polypropylene, acetal, acrylic, nylon (polyamides), polystyrene, polylactic acid (PLA), acrylonitrile butadiene styrene (ABS) and/or polycarbonate as the raw material, although other materials known in the art may also be utilized without departing from the broader aspects of the invention. In one embodiment, the extrusion apparatus 12 uses plastic pellets or granular shavings (e.g., recycled plastic pellets or granular shavings) as a raw material, as discussed hereinafter. The extrusion apparatus 12 may, in an embodiment, have an operating range between about 500 psi and 10,000 psi, and a length/diameter (L/D) ratio of about 24:1 or larger.

In an embodiment, the conduit 14 may be a heated conduit having a heating element 21 configured to control a temperature of the extrudate between the extrusion apparatus 12 and print head 16, as disclosed in U.S. patent application Ser. No. 17/024,794.

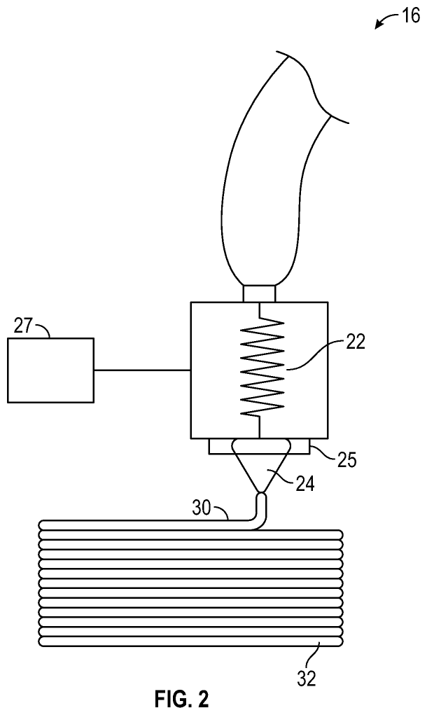

With reference to FIGS. 1 and 2, the print head 16 is fluidly connected to an opposite end of the conduit 14 and receives the extrudate therefrom. In an embodiment, the print head 16 includes a controllable heating element 22 and a nozzle 24. The heating element 22 is configured to further heat the extrudate material received from the heated conduit 14 to a molten or fluid state, or maintain the extrudate in such state, while the nozzle 24 is configured to controllably dispense the molten, flowable extrudate/print material 30 for deposition and formation, layer by layer, into an article 32. In an embodiment, the nozzle 24 includes a valve system for controlling material flow out of the nozzle (in dependence upon a particular part or article being printed). The nozzle 24 may include a mechanism such as, for example, a mechanical iris that can be selectively controlled to vary a dimeter of the nozzle opening and thus the diameter or the cross-sectional area of material being deposited. In an embodiment, the nozzle 24 may be selectively removable from the print head 16 so that nozzles having a variety of shapes and or sizes (e.g., square, oval, etc.) can be installed. Accordingly, it is contemplated that the outlet of the nozzle 24 may have a circular, square, oval, triangular, or other shaped cross-section.

The print head 16 may also include a cooling nozzle 25 adjacent to nozzle 24. In an embodiment, the cooling nozzle 25 may be in the shape of a ring or annulus surrounding the nozzle 24. The cooling nozzle is configured for connection to a supply of pressurized air and is controllable to direct the pressurized air onto the article being printed to cool the print material 30 as it is deposited to form the article 32. In an embodiment, the pressure of the air being output from the cooling nozzle 25 may be selectively controlled to provide faster or slower cooling of the print material 30.

In an embodiment, the print head 16 is preferably integrated with, or connected to a control and positioning system 27 for controlling a position of the print head and nozzle 24 thereof with respect to a substrate. In an embodiment, the control and positioning system may be a robotic arm or a CNC control system, although other control and positioning means known in the art may also be utilized without departing from the broader aspects of the invention. In an embodiment, the control and positioning system allows for movement of the nozzle 24 in any direction, and for 360 degree rotation about axis 26. In addition, the nozzle 24 can be tilted at any angle with respect to a vertical axis (e.g., the axis 26), from 0 degrees to 90 degrees.

In an embodiment, the extrusion apparatus 12, heated conduit 14 and print head 16 (as well as the movement system connected to the print head) are communicatively coupled to a centralized control unit 100. It is contemplated however, that in some embodiments, one or more of the extrusion apparatus 12, heated conduit 14 and print head 16 may have dedicated controllers for controlling operation of the respective devices (and which themselves may be communicatively coupled to a centralized controller). The control unit 100 is configured to control operation of the extrusion apparatus 12, such as controlling the temperature and extrusion rate thereof. The control unit 100 may also be configured to control a temperature of the heating element 21 of the heated conduit 14 so as to control the temperature of the extrudate material therein. Further, the control unit 100 is configured to control the position and orientation of the nozzle 24 (via control of the print head 16), as well as the heating element 22 and cooling nozzle 25 so as to control the temperature of the material as it reaches and exits the nozzle 24.

In operation, a raw material such as recycled plastic pellets or granular shavings are loaded into the hopper 18 of the extrusion apparatus 12. The extrusion apparatus 12, under control of the control unit 100, heats the pellets and pushes the melted pellets through a die to produce an extrudate at a first temperature. The flowable extrudate is then passed through the heated conduit 14 to the print head 16.

At the print head 16, the heating element 22 of the print head 16 heats the extrudate to a second temperature that is higher than the temperature within the heated conduit 14 (i.e., to the final melt temperature for printing), or maintains the temperature of the extrudate. The print head 16 then controllably moves under control of the control and positioning system operating according to a preprogrammed set of instructions to fabricate a desired article or structure. In particular, the control and positioning system is programmed with a set of instructions to control the deposit of material from the nozzle 24. Additional information relating to speeds, temperatures, stop/start, flow, and other properties may be input with the programming. The program is executed, inducing motion and extrusion to create any desired structure or article.

While the system 10 has been described as including an extruder 12 that is separate from the print head 16, in an embodiment, the extruder may be integral with the print head such as with a printer extruder that consumes filament, or a direct pellet extruder, or the like.

Regardless of the type of system employed, as indicated above, the height, width and temperature of the material being deposited or melted is critical in producing a part within desired tolerances, and to ensure each subsequent layer sufficiently bonds or fuses to the preceding layer. As further indicated above, variations in system components, ambient conditions, and the like, can sometimes have dramatic effects on the additive manufacturing process. For example, additive manufacturing systems using material extrusion to produce a bead of flowable extrudate, such as that described herein, can have fairly wide variations in extruder heating rates and screw shear rates, which can ultimately affect the bead output from the nozzle 24 and the manner in which, and reliability with which, it bonds to the preceding layer(s). These variations directly affect the bead of extrudate that is produced and deposited, thus affecting the quality of the object, part or component produced.

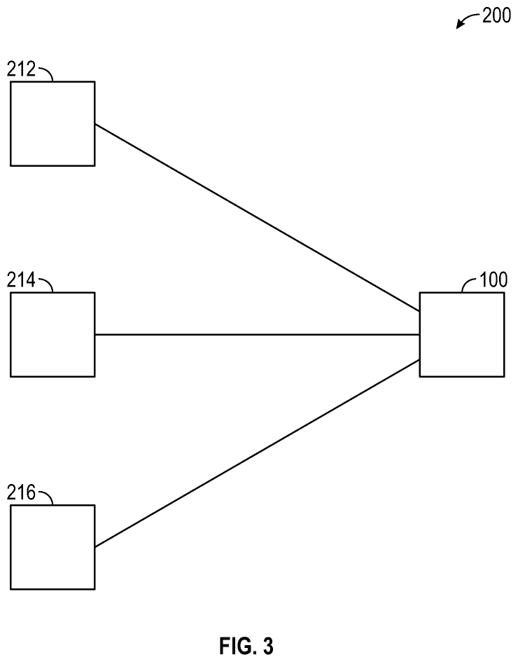

Accordingly, with reference to FIG. 3, in an embodiment, the system 10 of the present invention may further include a quality control system 200 having one or more sensing or monitoring devices configured to detect or monitor one or more bead parameters. These bead parameters may include, but are not limited to, previous layer/substrate temperature, bead temperature, bead shape, bead width, bead height, bead area and/or bead volume. In particular, in an embodiment, the quality control system 200 may include a measurement device 212 configured to scan or sense a 3-dimensional height (e.g., a height of the applied bead) during printing. In an embodiment, the measurement device 212 may be a laser measurement device located on the print head 16 adjacent to the nozzle 24, which looks down from the nozzle 24 at the object and bead 30 being applied. The laser measurement device 212 may be configured to determine a distance between the laser measurement device and the top surface of the bead 30, and to subtract such distance from a previously-calculated distance between the laser measurement device and the previous layer to determine the bead height. Other laser measurement devices or machine vision systems capable of determining the height of the bead 30 may also be employed.

While in the preferred embodiment, the measurement device 212 may be located on the nozzle 16 and be configured to view the layers from above, in another embodiment, the measurement device 212 may be configured to view the bead 30 from the lateral direction (rather than vertically downward) in order to detect the bead height.

With further reference to FIG. 3, the system 200 may also include a machine vision system or device 214 that, likewise, is located on the print head 16 adjacent to the nozzle 24, and which is configured to measure the bead width from above (from the nozzle looking downward).

As will be appreciated, the measurement devices 212, 214 may be used in combination to determine bead or layer area, volume and/or shape. The measurements and data (i.e., height, width, and/or shape) obtained from measurement devices 212, 214 can then be utilized by control unit 100 to detect any variations of bead specifications outside of preferred ranges, which may indicate, for example, over extrusion or under extrusion.

In addition to the above, in an embodiment, the quality control system 200 may further include a thermal vision system or device 216 configured to measure and record the temperatures of the currently printed/deposited and/or previously printed/deposited layers. The thermal vision device 216 is configured to measure the temperature of the layer being printed, as well as one or more of the previously printed layers. This allows the system 10 to control heating or cooling in specific areas of the printed part so that the layer adhesion quality is within desired, optimal ranges. For example, if it is determined that the bead being deposited is below the optimal temperature range (or if the temperature gradient, the difference in temperature between the bead being applied and the temperature of the previously applied layer is too great), the temperature of the bead may be increased or otherwise controlled by controlling extrusion, the heating element within the heated conduit and/or, the heating element within the print head to increase the temperature of the extrudate so that it exits the nozzle 24 within a desired temperature range.

Still further, the system 10 may also include one or more auxiliary heaters (not shown) that are configured to heat one or more previously-deposited layers. For example, if it is determined using the thermal vision device 216 that one of the previously formed layers is below a desired temperature range for optimal bonding with a bead being deposited, the auxiliary heater may be used to heat the previously applied layer to be within the optimal temperature range (e.g., by applying hot air to the underlying layer). In an embodiment, the system 10 may use both primary heating (via selective control over the extruder, heating element within the heated conduit or heating element within the print head) and auxiliary heating to achieve a desired temperature gradient or match between the temperature of the previously-applied layer, and the layer currently being deposited.

In addition to the above, the speed of movement of the print head and/or the cross-sectional area of the nozzle opening may also be adjusted to achieve a desired bead shape and/or configuration (e.g., area, height, width, etc.).

In an embodiment, one or more of the measurement devices 212 214, 216 may be mounted and/or configured to orient itself in the direction of movement of the nozzle 16 so as to provide 360 degree viewing capability and detection of bead height, regardless of nozzle position or direction.

In connection with the above, and as shown in FIG. 3, each of the measurement devices 212, 214, 216 is communicatively coupled to the control unit 100 for transmission of the measurements taken to the control unit 100, for use in taking corrective action or for quality control purposes. Alternatively, in an embodiment, each of the devices 212, 214, 216 (or the system 200, as a whole) can have a dedicated controller that is, in turn, communicatively coupled to a master control unit (e.g., control unit 100). Importantly, the measurement devices 212, 214, 216 of the quality control system 200 determine the precise dimensional and temperature parameters/specifications of the bead being applied, as well as such parameters of preceding layers, which can then be utilized by the control unit 100 to make corrective machine setting changes in real-time, or if the tolerance is past the limit of error it can stop the print. In addition, the data collected during the printing process can be stored and used for quality control purposes. In this respect, the system 200 is capable of mapping the entire printing process and the actual parameters of each layer as it is deposited (and even thereafter). In an embodiment, the system 200 may be configured and utilized to map the height, width and temperature of the entire printed object on a pixel-by-pixel basis, which can be stored and later used for quality control purposes.

In an embodiment, the stored data can also be utilized to retroactively assess and examine potential causes of failure of a component or object. For example, if a part, object or component ultimately fails or breaks at some point subsequent to production, the points/locations of failure can be cross-referenced against the stored data in order to determine if certain print parameters (bead shape, bead temperature, substrate temperature, etc.) may have resulted in or contributed to the failure. This analysis and the data extracted therefrom can then be utilized to improve subsequent prints.

As discussed above, the quality control system 200 of the present invention is therefore utilized to monitor and acquire data about the surface layers and the bead being formed/deposited (i.e., visual, thermal and dimensional measurements), which can then be used by the control unit 100 to make comparative measurements against the desired part model stored in memory. That is, in response to these measurements, the system 10, and the control unit 100 therefore, is configured to make, record, and quantify the corrective settings to ensure the bead being applied is within specifications, or to pause the manufacturing process to make any necessary adjustments. In this respect, the system 10 is able to make real-time measurements of the printing process, and make real-time adjustments to the pre-programmed process. This is in contrast to existing methods whereby the printing process is carried out strictly according to a program stored in memory. The ability to provide real-time, in process adjustments adds another layer of control to the overall additive manufacturing process.

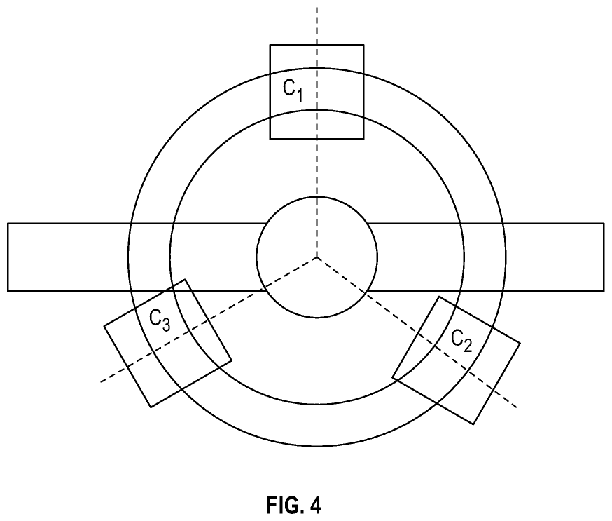

Referring finally to FIG. 4, in another embodiment, the system 200, may include three cameras C1, C2, C3, each with viewing angles no less than 120 degrees, to monitor the surface layers and bead, and to acquire the dimensional and temperature data of each layer and bead. Such a system can be utilized in place of a single camera that is adjustable 360 degrees in dependence upon the orientation and direction of the nozzle.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A system for additive manufacturing, comprising:
an extrusion apparatus configured to receive a raw material and to output an extrudate;
a print head configured to receive the extrudate and to output a bead to form an object; and
a quality control system having at least one measurement device for measuring at least one of a bead width, a bead height and/or a bead temperature of the bead.

2. The system according to claim 1, further comprising:
a controller communicatively coupled to the quality control system and being configured to adjust a setting of the extrusion apparatus and/or the print head in real-time in response to the measurement from the at least one measurement device.

3. The system according to claim 2, wherein:
the controller is configured to compare the at least one measurement to a measurement range stored in memory, and to adjust the setting of the extrusion apparatus and/or the print head in real-time if the measurement is outside of the measurement range.

4. The system according to claim 1, wherein:
the at least one measurement device is configured to determine a width of the bead.

5. The system according to claim 1, wherein:
the at least one measurement device is configured to determine a height of the bead.

6. The system according to claim 1, wherein:
the at least one measurement device is configured to determine a temperature of the bead.

7. The system according to claim 1, wherein:
the at least one measurement device is configured to determine a temperature of a previously applied layer of the object.

8. The system according to claim 1, wherein:
the system further includes a conduit fluidly connected to the extrusion apparatus and to the print head, the conduit being configured to receive the extrudate from the extrusion apparatus and to convey the extrudate to the print head.

9. The system of claim 8, wherein:
the conduit includes a controllable heating element for selectively controlling a temperature of the extrudate passing through the conduit.

10. The system of claim 9, wherein:
the controller is configured to adjust a setting of the heating element of the conduit in real-time in response to the measurement from the at least one measurement device.

11. The system of claim 1, wherein:
the at least one measurement device is a laser measurement device.

12. The system of claim 1, wherein:
the at least one measurement devices includes three cameras, each camera having a viewing angle of at least 120 degrees.

13. The system of claim 1, further comprising:
a cooling nozzle adjacent to the print head, the cooling nozzle being configured to output pressurized air to cool at least one of the bead and/or a substrate in response to data acquired by the at least one measurement device.

14. A method of additive manufacturing, comprising the steps of:
depositing a bead of material on a substrate according to a set of pre-programmed instructions;
measuring at least one parameter of at least one of the bead and/or the substrate;
comparing the measurement to a reference measurement stored in memory; and
controlling at least one component of an additive manufacturing system in dependence upon the comparison.

15. The method according to claim 14, wherein:
the at least one parameter is a width of the bead, a height of the bead and/or a temperature of the bead.

16. The method according to claim 14, wherein:
the at least one parameter includes a temperature of the substrate.

17. The method according to claim 14, wherein:
the additive manufacturing system includes an extrusion apparatus configured to receive a raw material and to output an extrudate, a conduit having a heating element and being configured to receive the extrudate from the extrusion apparatus, and a print head configured to receive the extrudate from the conduit and to output the bead to form the object;
wherein the step of controlling the at least one component includes at least one of adjusting a setting of the extrusion apparatus, a nozzle of the print head, a heating element of the print head, or the heating element of the conduit in response to the comparison.

18. The method according to claim 17, further comprising the step of:
blowing air onto at least one of the bead and/or the substrate to decrease the temperature of the bead and/or the substrate.

19. A system for additive manufacturing, comprising:
a print head configured to output a bead of flowable material to form an object; and
a quality control system having at least one measurement device for obtaining a measurement of at least one of a bead width, a bead height and/or a bead temperature of the bead;
wherein the quality control system is configured to compare the measurement of the bead width, the bead height and/or the bead temperature of the bead with a reference measurement stored in memory and to adjust the system for additive manufacturing in real-time in dependence upon the comparison.

20. The system of claim 19, wherein:
the quality control system is configured to control at least one of a heating element, a cross-sectional area of a nozzle, and/or a speed of a control and positioning system of the system for additive manufacturing in response to the comparison.
